(19) United States
(12) Patent Application Publication
(10) Pub. No.: US 2002/0053321 A1
(43) Pub. Date: May 9, 2002

(54) Coating film forming apparatus and coating film forming method

(75) Inventors: Hiroshi Tomita, Kikuchi-Gun (JP); Kunie Ogata, Kikuchi-Gun (JP); Kiminari Sakaguchi, Kikuchi-Gun (JP); Yasuharu Iwashita, Kikuchi-Gun (JP); Ryouichi Uemura, Kikuchi-Gun (JP); Masahiro Nakatsuru, Kikuchi-Gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKYO ELECTRON LIMITED, Tokyo-To (JP)

(21) Appl. No.: 09/984,152

(22) Filed: Oct. 29, 2001

(30) Foreign Application Priority Data
Nov. 6, 2000 (JP) 2000-337764

(51) Int. Cl. B05D 3/12

(52) U.S. Cl. 118/501; 427/240; 427/10; 427/346; 118/697

(57) ABSTRACT

A plurality of production line recipes and film thickness measurement recipes that recite the same type of coating solution, but different target film thickness are prepared in a coating unit. Recipes that recite the same types of coating solution and the same film thickness are linked to a common spin curve. A film thickness measurement recipe is executed so as to calculate a compensated value for a revolving speed for each measured data of the film thickness. The designated values of revolving speeds of individual recipes can be compensated using the compensated value at a time.

### BACKGROUND OF THE INVENTION

1. Field of the Invention

The present invention relates to a coating film forming apparatus and a coating film forming method for forming a coating film on the front surface of a substrate such as a semiconductor wafer or an LCD (Liquid Crystal Display) glass substrate with supplying coating solution such as resist solution.

2. Description of the Related Art

In a process for producing semiconductor devices and LCDs, a technology termed photolithography has been employed. In the photolithography technology, resist solution is coated on a substrate (for example, a semiconductor water) so as to form a coating film on the front surface of the substrate. With a photo mask, resist film is exposed. Thereafter, a developing process is performed for the exposed resist film. As a result, a resist pattern is formed.

In the producing process, the coating step for the resist solution is performed by for example spin coating method. In the method, a substrate is horizontally sucked and held with a rotatable spin chuck. While resist solution is supplied to the substrate from a nozzle disposed at an upper center portion thereof, the spin chuck is revolved. In the spin coating method, the resist solution is spread by centrifugal force and thereby a coating film is equally formed on the entire substrate.

In the method, since the revolving speed of the substrate is proportional to the centrifugal force, the film thickness of the coating film of the resist solution (the resist solution that has been just coated is a liquid film) depends on the revolving speed of the substrate. On the other hand, since the resist film is exposed and developed in the process condition corresponding to the film thickness thereof, it is required that the film thickness should satisfy a predetermined value. To do that, the revolving speed at the coating step (namely, shake-off revolving speed) is adjusted. However, due to various factors such as fluctuations of temperature, humidity, and so forth, surface condition of wafer, and atmospheric pressure, the real film thickness may deviate from target film thickness.

To solve such a problem, conventionally, whenever a predetermined number of substrates are processed, a substrate is removed as a sample substrate from a coating film forming apparatus. The sample substrate is transferred to a film thickness measuring unit disposed as an external unit of the apparatus. The film thickness of the sample substrate is measured by the film thickness measuring unit. Corresponding to the measured result, it is determined whether or not the revolving speed of the spin chuck is proper. Corresponding to the determined result, the revolving speed is compensated so that the film thickness of the resist films of the substrates that will be supplied to the production line satisfies the target film thickness.

However, since such a compensating operation does not have a criterion for deciding a proper revolving speed, the increase or decrease of the revolving speed should have been decided on trial and error basis through the operator's experience.

However, the above-described coating step is performed corresponding to a recipe that pre-designates the type of resist solution that is used, the target film thickness of the liquid film, and so forth. Thus, when a plurality of types of recipes that differ in values of target film thickness are used in one coating unit or when each coating unit uses a different recipe, the operator should repeat the compensating operation for each recipe. Thus, the operator should spend much time for the operation.

### SUMMARY OF THE INVENTION

The present invention is made from the above-described point of view. An object of the present invention is to provide a technology that allows the revolving speed of a substrate to be easily compensated so that the film thickness of the coating film satisfies the target film thickness when the coating film is formed by the spin coat method.

A first aspect of the present invention is a coating film forming apparatus, comprising a carrier holding portion holding a carrier that contains a plurality of substrates, a transfer mechanism extracting a substrate from the carrier held on the carrier holding portion and transferring the substrate, a coating unit, having a substrate holding portion for horizontally holding the substrate transferred from the transfer mechanism, the coating unit supplying coating solution to the substrate, and rotating the substrate holding portion so as to spread the coating solution on the substrate with a centrifugal force of a revolving speed of the substrate and thereby form a coating film on a front surface of the substrate, a film thickness measuring unit measuring the film thickness of the coating film formed on the front surface of the substrate, a data storing portion storing revolving speed—film thickness data that represents the relation between the revolving speed of the substrate and the film thickness of the coating film coated in a coating process by the coating unit, a recipe creating portion creating a recipe that recites a process condition group containing a target film thickness of the coating film of the coating unit and the revolving speed of a plurality of said substrates at which the coating process is performed by the coating unit, and a revolving speed compensating portion compensating a set value of a plurality of the revolving speeds corresponding to the target film thickness designated by the created recipe, the measured data of the film thickness, and the revolving speed—film thickness data assigned to the recipe so that the film thickness of the coating film satisfies the target value, wherein a plurality of recipes are assigned to a common revolving speed—film thickness data, when the revolving speed of one recipe is compensated, the revolving speeds of the other recipes being compensated. In such a structure, when the revolving speed of one recipe is compensated, the compensated result can be reflected to all recipes to which common revolving speed—film thickness data is assigned. Thus, the operator does not need to calculate the compensation value for the coating film formed for each recipe. As a result, the labor imposed to operator can be alleviated.

As a real example of the compensation of the revolving speeds, the revolving speed compensating portion decides a compensated value of the revolving speed corresponding to the average value of film thickness of substrates based on the measured data of the film thickness, the target film thickness, and the revolving speed—film thickness data. As for the compensation value, using each recipe to which the common revolving speed—film thickness data is assigned, coating films are formed. The average value of the compensation values of revolving speeds obtained from the measured results of the coating films is obtained. The average value may be used.

The plurality of recipes assigned to the common revolving speed—film thickness data recite the same types of coating solution, but different target film thickness. The plurality of recipes assigned to the common revolving speed—film thickness data contain a production recipe and a film thickness measurement recipe, the production recipe being used to produce substrates, the film thickness measurement recipe being used to perform the coating process for a monitor substrate under the same condition as the production recipe and measure the film thickness thereof. The revolving speed—film thickness data is assigned to each recipe by inputting the name of the revolving speed—film thickness data on a set up screen of the recipe creating portion.

The film thickness is calculated for each revolving speed based on the common revolving speed—film thickness data of which the revolving speeds of the recipes have been compensated. In addition, it is determined whether or not each calculated result satisfies an allowable range against measured results of the film thickness of coating films formed at each revolving speed. When each film thickness does not satisfy the allowable range, for example an alarm may be output. Thus, the reliability of the compensation can further be improved.

A second aspect of the present invention is a coating film forming method, comprising the steps of creating a recipe that recites target film thickness of a coating film formed on a substrate and a revolving speed of the substrate at which a coating process is performed by a coating unit, causing the coating unit to supply coating solution to the substrate, revolve the substrate along the horizontal surface at the revolving speed designated at the creating step so as to spread the coating solution with the centrifugal force and form the coating film on a front surface of the substrate, measuring the thickness of the coating film formed on the front surface of the substrate, deciding a compensated value of the revolving speed corresponding to the target film thickness designated in the recipe, the measured data of film thickness of the coating film measured at the measuring step, and pre-created revolving speed—film thickness data assigned to the recipe so as to reach the film thickness of the coating film to a target value, and compensating the revolving speeds of other recipes assigned to the common revolving speed—film thickness data when the revolving speed of one of the recipes is compensated.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a plan view showing the overall structure of a coating film forming apparatus according to an embodiment of the present invention;

FIG. 2 is a perspective schematic view showing the coating film forming apparatus according to the embodiment of the present invention;

FIG. 3 is a vertical sectional view showing principal portions of a coating unit;

FIG. 4 is a vertical sectional view showing principal portions of a film thickness measuring unit;

FIG. 5 is a block diagram showing a controlling portion according to the embodiment;

FIG. 6 is a descriptive view showing a part of an input screen of a recipe creating portion;

FIG. 7 is a descriptive view showing a stored state of recipes and spin curves in the controlling portion;

FIG. 8 is a descriptive view showing a state of which a plurality of recipes are linked to one spin curve;

FIG. 9 is a descriptive view showing an example of a transferring path of a wafer according to the embodiment;

FIG. 10 is a flow chart showing a process for designating a revolving speed according to the embodiment;

FIG. 11 is a flow chart showing a process for compensating a revolving speed according to the present invention;

FIG. 12 is a descriptive view showing a process for compensating a revolving speed according to the embodiment;

FIG. 13 is a descriptive view showing a spin curve of which a revolving speed has been compensated; and

FIG. 14 is a flow chart showing a process of which after a revolving speed is compensated, film thickness is verified.

### DESCRIPTION OF PREFERRED EMBODIMENTS

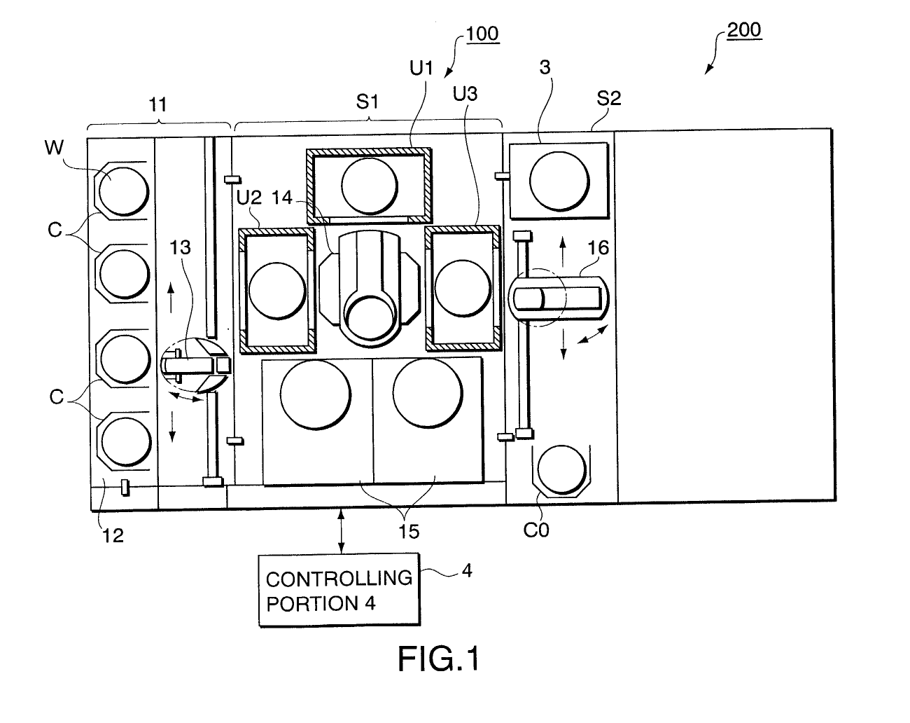

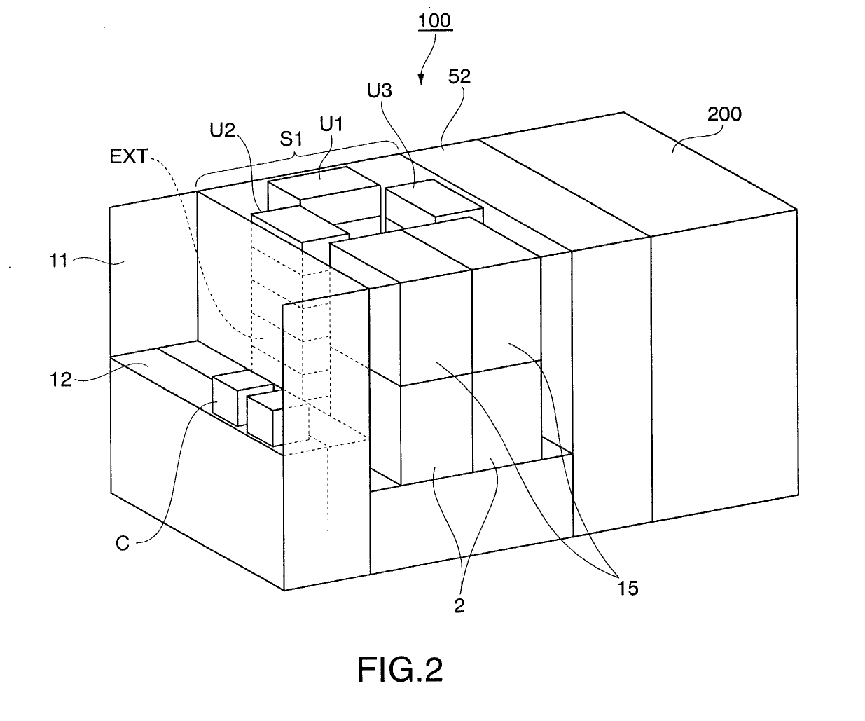

Next, a coating film forming apparatus applied for use with a coating process and a developing process will be described as an embodiment of the present invention. The coating film forming apparatus is composed of a main boy and a controlling portion. The main body transfers and processes a substrate. First of all, the main body of the apparatus will be described in brief. FIGS. 1 and 2 are a plan view and a perspective view showing the overall structure of a resist pattern forming apparatus in which a coating and developing apparatus 100 is connected to an aligner 200.

In FIGS. 1 and 2, reference numeral 11 represents a carrier station that loads and unloads a carrier C that contains a plurality of semiconductor wafers (referred to as wafers) W that are for example 25 substrates to/from the apparatus 100. The carrier station 11 comprises a carrier holding portion 12 and an transfer mechanism 13. The transfer mechanism 13 extracts a wafer W, which is a substrate, from a carrier C and transfers the extracted wafer W to a processing portion S1 disposed inside the carrier station 11.

A main transfer mechanism 14 is disposed at the center of the processing portion S1. Viewed from the carrier station 11 toward the interior, on the right, two coating units 2 and two developing units 15 are disposed; on the left, front side, and rear side, shelf units U1, U2, and U3 are disposed, respectively. Each of the shelf units U1, U2, and U3 vertically arranges heating and cooling units on a plurality of stages. In this example, two coating units 2 and two developing units 15 are disposed. The two coating units 2 are disposed below the two developing units 15, respectively. In each of the shelf units U1, U2, and U3, along with the heating units and cooling units, a wafer exchanging unit, a hydrophobic process unit, and so forth are vertically arranged. A main transfer mechanism 14 is structured so that it can be freely lifted up and down, moved forward and backward, and revolved around the vertical axis. The main transfer mechanism 14 has a function for transferring a wafer W among the shelf units U1, U2, and U3, the coating units 2, and the developing units 15. For simplicity, in FIG. 2, the transfer mechanism 13 and the main transfer mechanism 14 are not illustrated.

The processing portion S1 is connected to the aligner 200 through an interface portion S2. The interface portion S2 is provided with an transfer mechanism 16, a buffer cassette C0, and a film thickness measuring unit 3. For example, the transfer mechanism 16 is structured so that it can be freely lifted up and down, moved leftward, rightward, forward, and backward, and revolved around the vertical axis. The transfer mechanism 16 exchanges a wafer W among the processing portion S1, the aligner 200, the buffer cassette C0, and the film thickness measuring unit 3.

Next, the flow of a wafer in the pattern forming apparatus will be described. First of all, a carrier C is transferred from the outside of the apparatus 100 to the carrier holding portion 12. A wafer W is extracted from the carrier C by the transfer mechanism 13. The extracted wafer W is transferred from the transfer mechanism 13 to the main transfer mechanism 14 through an exchanging unit EXT of the shelf unit U2 (see FIG. 2). In the apparatus 100, and predetermined processes for example a hydrophobic process and a cooling process are performed. Thereafter, resist solution is coated to the wafer W by the coating unit 2. Thereafter, a heating process is performed for the wafer W. As a result, solvent of the resist solution is volatilized. Thereafter, the wafer W is transferred from an exchanging unit (not shown) of the shelf unit U3 to the aligner 200 through the interface portion S2.

The wafer W is exposed by the aligner 200. The exposed wafer W is returned to the processing portion S1 through the reverse path. Thereafter, the wafer W is transferred to one of the developing units 15 by the main transfer mechanism 14. A developing process is performed for the wafer W by the developing unit 15. Strictly speaking, before and after the developing process is performed, a heating process and a cooling process are performed for the wafer W. The wafer W that has been developed is transferred to the transfer mechanism 13 through the reverse path and returned to the original carrier C held on the carrier holding portion 12.

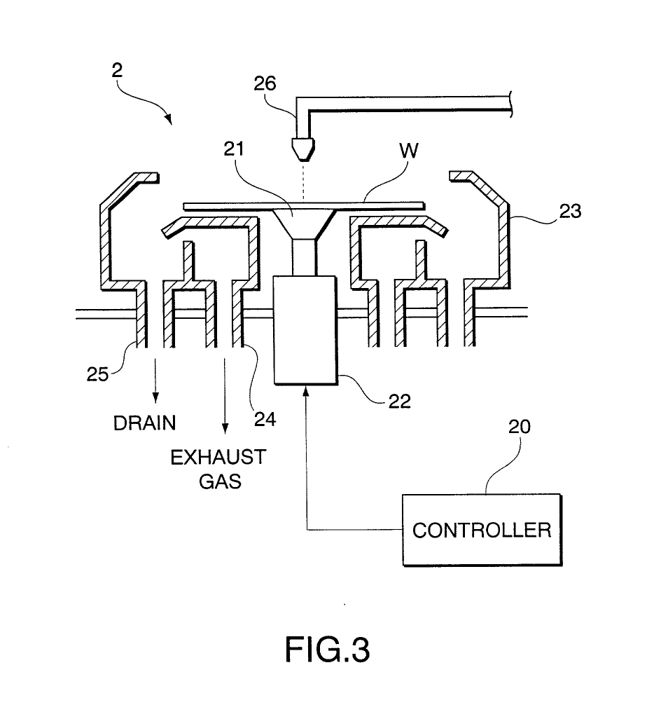

Next, the coating unit 2 and the film thickness measuring units 3 will be described. First of all, an example of the coating units 2 will be described in brief with reference to FIG. 3. In FIG. 3, reference numeral 21 represents a spin chuck, reference numeral 22 represents a driving portion of the spin chuck 21, reference numeral 23 represents a liquid receiving cup, reference numeral 24 represents an exhaust pipe, reference numeral 25 represents a drain pipe, reference numeral 26 represents a resist solution supply nozzle. When the wafer W is transferred to the spin chuck 21 by the main transfer mechanism 14, the resist solution is supplied from the resist solution supply nozzle 26. In addition, the spin chuck 21 is revolved. The resist solution is spread toward the outer periphery of the wafer W by the centrifugal force. As a result, a liquid film (coating film) is formed on the front surface of the wafer W. The resist solution that is shaken off flows to the liquid receiving cup 23.

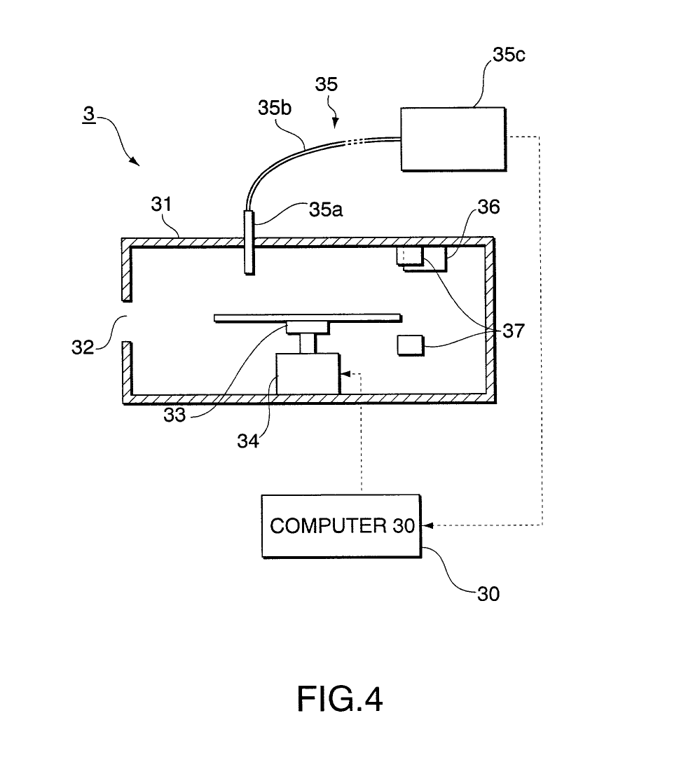

As shown in FIG. 4, the film thickness measuring unit 3 of the interface portion S2 is provided with a casing 31, a holding table 33, a driving mechanism 34, and an optical interference type film thickness meter 35. The casing 31 has a loading opening 32 on one side. The holding table 33 holds a wafer W loaded to the casing 31. The holding table 33 is freely revolved and moved in the X and Y directions by the driving mechanism 34. The optical interference type film thickness meter 35 is provided with a probe 35a, an optical fiber 35b, and a spectroscope unit 35c. The probe 35a is disposed so that it faces the front surface of the wafer W. The spectroscope unit 35c contains a spectroscope and a controller. The optical interference type film thickness meter 35 obtains a spectrum corresponding to light reflected on the front surface of the wafer W and detects the film thickness of the wafer W corresponding to the spectrum.

In the film thickness measuring unit 3, the wafer W is moved in the X and Y directions. When probes 35a are disposed at many positions along the diameter of the wafer W, the film thickness at each position of the wafer W can be measured. In FIG. 4, reference numeral 30 represents a computer. The computer 30 has functions for causing the driving mechanism 34 to move the holding table in the X and Y directions and processing a signal obtained by the spectroscope unit 35c so as to obtain the film thickness at each position of the wafer W, create the distribution of the film thickness, and obtain the average value of the film thickness and so forth.

To remove resist from the periphery of the wafer W, the film thickness measuring unit 3 is structured in common with a periphery aligner that exposes the peripheral portion. In the casing 31, an exposing means 36 is disposed. In addition, a pair of line sensors 37 are disposed so that they sandwich the path of the wafer W.

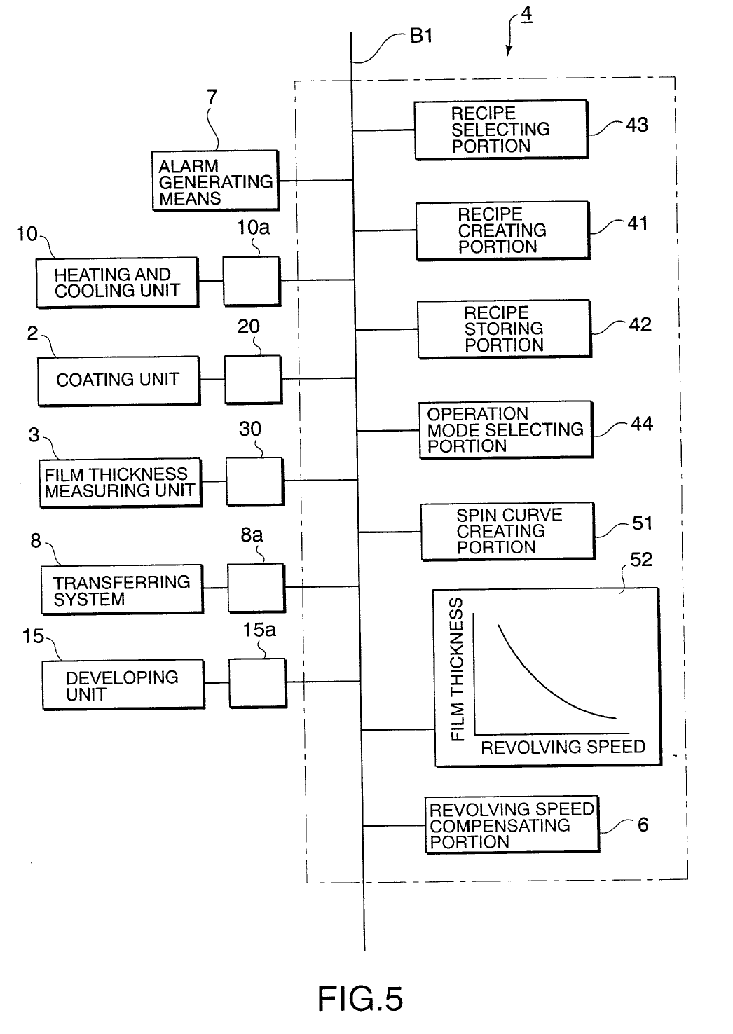

Returning to FIG. 1, the coating and developing apparatus 100 is provided with a controlling portion 4. The controlling portion 4 manages recipes with which individual processing unit operate. FIG. 5 shows the structure of the controlling portion 4. Although the controlling portion 4 is composed of a CPU (Central Processing Unit), a program, a memory, and so forth, each function is described as a block of a structural element. In FIG. 5, reference numeral 41 represents a recipe creating portion, reference numeral 42 represents a recipe storing portion, reference numeral 43 represents a recipe selecting portion. The recipe creating portion 41 can input a recipe that recites a combination of process conditions necessary for the coating process such as the type of a resist, target film thickness (for example, target value of average film thickness on the front surface of a wafer), the revolving speed of a wafer W at which a coating film is formed (shake-off revolving speed), and revolving time. Each recipe that is created is stored in the recipe storing portion 42. In other words, each recipe contains process conditions of the coating unit 2. The recipe storing portion 42 is a block that includes the role of a process condition storing portion set forth in claims of the present invention. The recipe creating portion 41 comprises a recipe creating program, and an operation screen with which a recipe is input and edited. A plurality of recipes are provided corresponding to a plurality of types of coating films. Thus, the operator selects a desired recipe from the plurality of types of recipes stored in the recipe storing portion 42 using the recipe selecting portion 43. In FIG. 5, a portion B1 represents a bus.

The controlling portion 4 is further provided with a spin curve creating portion 51 and a spin curve storing portion 52. The spin curve storing portion 52 is a data storing portion. A spin curve is revolving speed—film thickness data that represents the correlation between the revolving speed of a wafer W at which the coating process is performed in the coating unit 2 and the average film thickness obtained corresponding to the measured data of the film thickness of the resist film formed on the front surface of the wafer W at the revolving speed (namely, the resist film from which the solvent of the resist solution has been volatilized). For example, a spin curve is an approximation expression that represents the correlation. A spin curve is displayed on a displaying screen as a graph of revolving speed and film thickness on horizontal axis and vertical axis, respectively. The spin curve creating portion 51 is provided with a spin curve creating program and a displaying portion that displays a spin curve created by the program and so forth. In a spin curve creating mode, using a plurality of monitor wafers that are monitor substrates, the coating unit 2 forms resist films at various revolving speeds. In addition, the film thickness measuring unit 3 measures the film thickness of each resist film. Corresponding to the revolving speed—film thickness data, a spin curve is created.

The controlling portion 4 is further provided with an operation mode selecting portion 44, a revolving speed compensating portion 6, and an alarm generating portion 7. The operation mode selecting portion 44 selects an operation from a product wafer processing mode (in which each of the coating process, the exposing process, and the developing process is controlled corresponding to a recipe created by the recipe creating portion 41), a spin curve creating mode, and so forth using for example an operation panel of the apparatus. Even if a coating film is formed corresponding to a recipe, the film thickness of the resist solution coated on the front surface of a wafer W may deviate from the expected film thickness depending on temperature, humidity, quality of the wafer, and so forth. Thus, the revolving speed compensating portion 6 compensates the revolving speed corresponding to the spin curve so that the film thickness of the resist solution coated on the film thickness satisfies the expected film thickness. When an abnormal value takes place in the distribution of the film thickness, the calculation result, or the like as the execution result of the revolving speed compensating program, the alarm generating portion 7 generates an alarm in such a manner that a buzzer sound is generated, an alarm sound lights, or an alarm message appears on the operation panel.

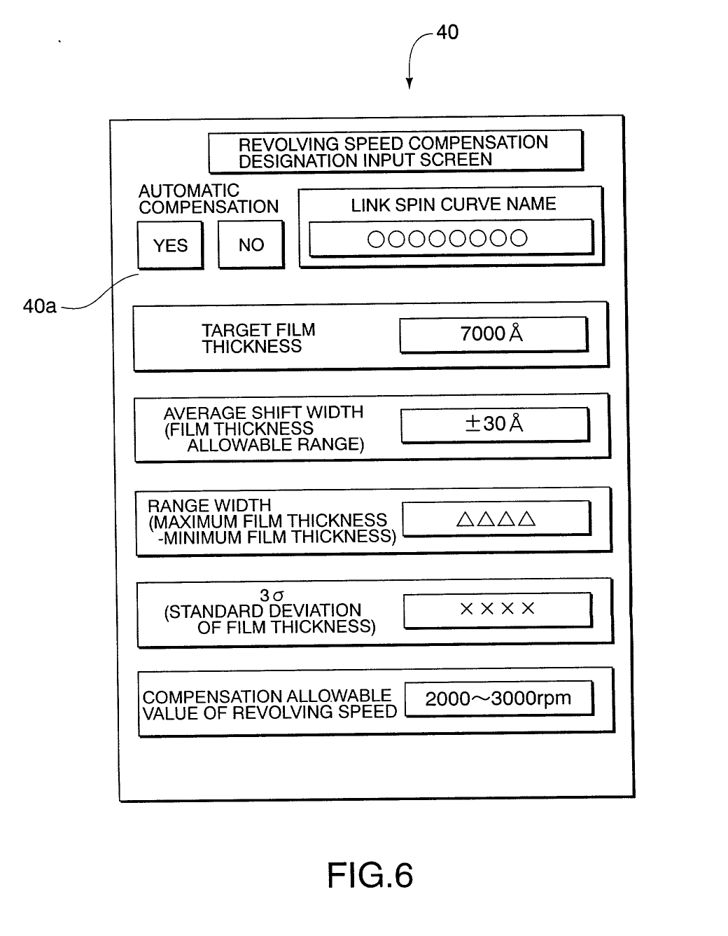

FIG. 6 shows an example of a revolving speed compensation designation value input screen that is one of recipe creating screens of the coating unit 2. On a screen 40, a link spin curve name is the name of a spin curve that the recipe uses. Since the relation between the revolving speed and the film thickness depends on the type of each resist, when the revolving speed for a target film thickness is set or the revolving speed is compensated, it is necessary to designate the revolving speed based on a spin curve corresponding to a resist that is used. Since a plurality of spin curves have been prepared by the spin curve storing portion 52, the operator selects a spin curve linked to the recipe therefrom and inputs the name thereof.

In addition to the target film thickness of the resist film, the average shift width, range width, 3 and revolving speed compensation allowable value can be input. The average value shift width is a film thickness allowable range. When the average film thickness satisfies the range, this situation can be treated as a normal state. The range width is the difference between the maximum film thickness and the minimum film thickness in the distribution of film thickness of the front surfaces of the wafers W. 3 is a value three times larger than the standard deviation in the distribution of film thickness. When the real distribution of film thickness deviates from these designated values as the execution result of the revolving speed compensation program, this situation is treated as an abnormal state. When the compensation amount (revolving speed compensation value) for compensating the current revolving speed is obtained by the revolving speed compensation program, if the obtained compensation amount deviates from the designated value as the revolving speed compensation allowable value, this situation is treated as an abnormal state. In other words, these values are equivalent to threshold values at each determining step of the revolving speed compensation program. Some of these values are pre-designated for convenience. On the screen 40, a selecting portion 40a is provided. The selecting portion 40a is used to select “yes” or “no” of the automatic revolving speed compensation. According to the embodiment, it is assumed that “yes” has been selected for the automatic compensation.

In addition, the controlling portion 4 is connected to the coating unit 2, the developing unit 15, the heating and cooling unit 10, the transferring system 8 (such as the main transfer mechanism 14, and the transfer mechanism 13 and 16), and the film thickness measuring unit 3 disposed in each of the shelf units U1, U2, and U3 through the controllers 20, 15a, 10a, 8a, and the computer 30, respectively.

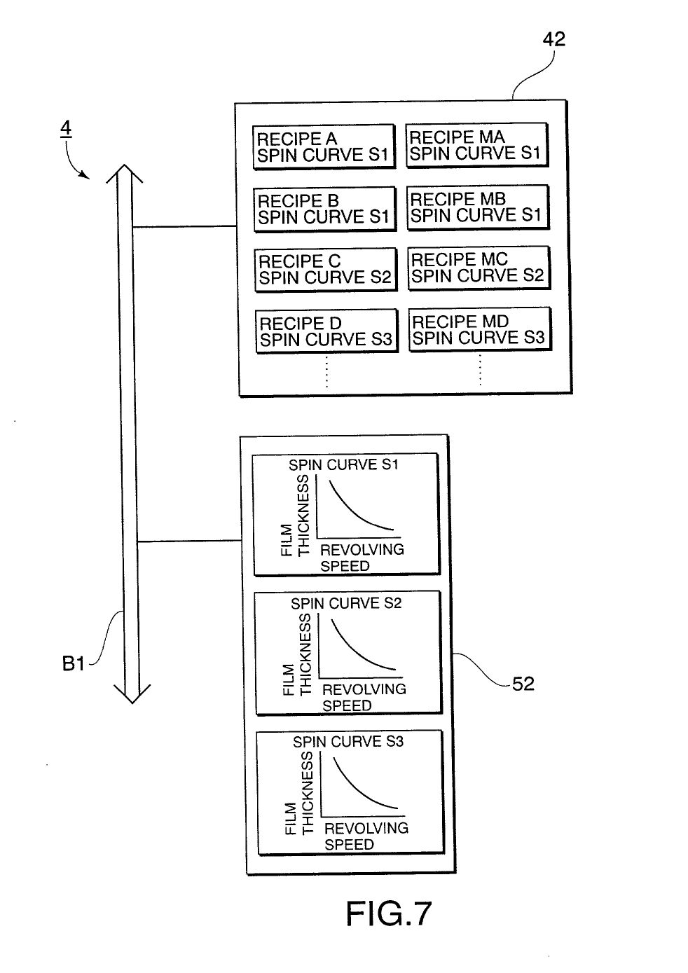

Next, the relation between spin curves and recipes will be described. As was described above, according to the embodiment, on the recipe creating screen, a spin curve that a recipe references is input. Each spin curve created corresponding to the revolving speed—film thickness data is stored in the spin curve storing portion 52. In addition, as shown in FIG. 7, all recipes are stored as pairs of recipe A—spin curve S, recipe MA—spin curve S1, and so forth. In this case, the term “a recipe and a spin curve are linked” represents that because when the shake-off revolving speed for a substrate is obtained corresponding to the target film thickness designated by a recipe, the computer references the spin curve. In reality, when the revolving speed corresponding to the target film thickness of the recipe is obtained, the area (address) called from the storing portion is the area for the data of the spin curve.

There are two types of recipes. They are categorized depending on whether or not a wafer W is transferred through the film thickness measuring unit 3. The former is a recipe used in so-called production mode in which regular products are produced). This recipe is equivalent to recipes A to D shown in FIG. 7. The latter is a recipe used in film thickness measurement mode so as to compensate the revolving speed in the coating unit 2 corresponding to the measured data of the film thickness obtained in the film thickness measuring unit 3. This recipe is equivalent to recipes MA to MD.

As is clear from the object of each mode that has been described above, with respect to the types of wafers used in each recipe, in the production mode, product wafers are used, whereas in the film thickness measurement mode, if necessary, product wafers and monitor wafers as film thickness measurement substrates can be selectively used. In reality, when the revolving speed is compensated, corresponding to a recipe in the production mode, product wafers are processed. For example, whenever a predetermined number of wafers have been processed, using a recipe in the film thickness measurement mode, the film thickness of the resist films of the product wafers is measured. Alternatively, monitor wafers composed of paired wafers may be used. In this example, the latter case will be described.

In addition, as is clear that the spin curve S1 is linked to each of the recipes A, B, MA, and MB shown in FIG. 7, a plurality of recipes can be linked to one common spin curve. As was described above, a recipe in the film thickness measurement mode is used to compensate the revolving speed of a wafer W in the coating unit 2 and thereby the film thickness of coating films becomes proper in the production mode. Thus, a recipe in the production mode and a recipe in the film thickness measurement mode are linked to one spin curve. Consequently, the compensated result of the revolving speed obtained corresponding to a recipe in the film thickness measurement mode is reflected to a recipe in the production mode that is linked to the common spin curve.

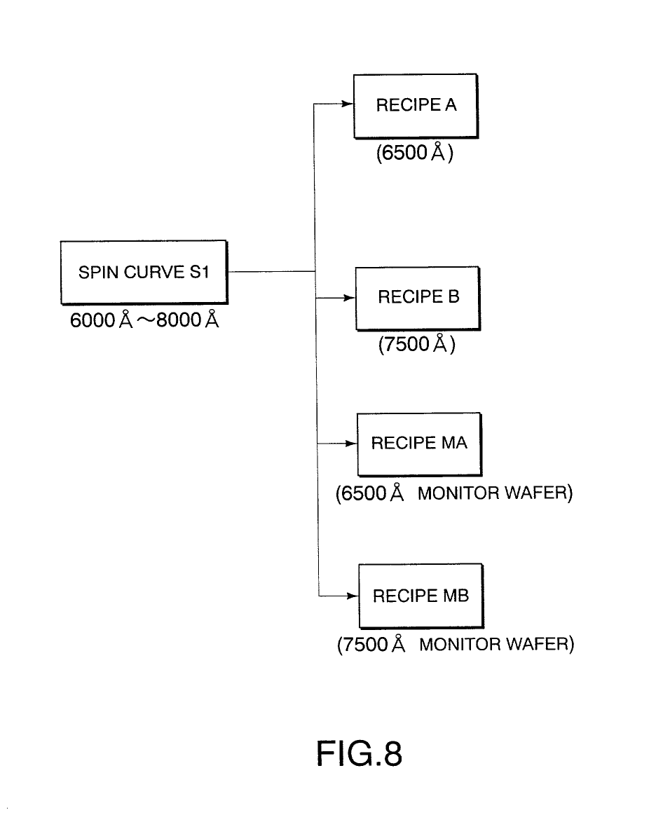

For example, as shown in FIG. 8 when the recipe A (target film thickness 6500 Å) in the production mode, the recipe B (target film thickness 7500 Å) in the production mode, the recipe MA (target film thickness 6500 Å) in the film thickness measurement mode, and the recipe MB (target film thickness 7500 Å) in the film thickness measurement mode are linked to the spin curve S1 for coating films whose film thickness ranges from 6000 Å to 8000 Å, the recipes MA and MB corresponding to the recipes A and B, respectively, the recipes A, B, MA, and MB reference the spin curve S1. The compensated result of the revolving speed obtained by for example the recipe MA and/or the recipe MB is reflected to other recipes linked to the spin curve.

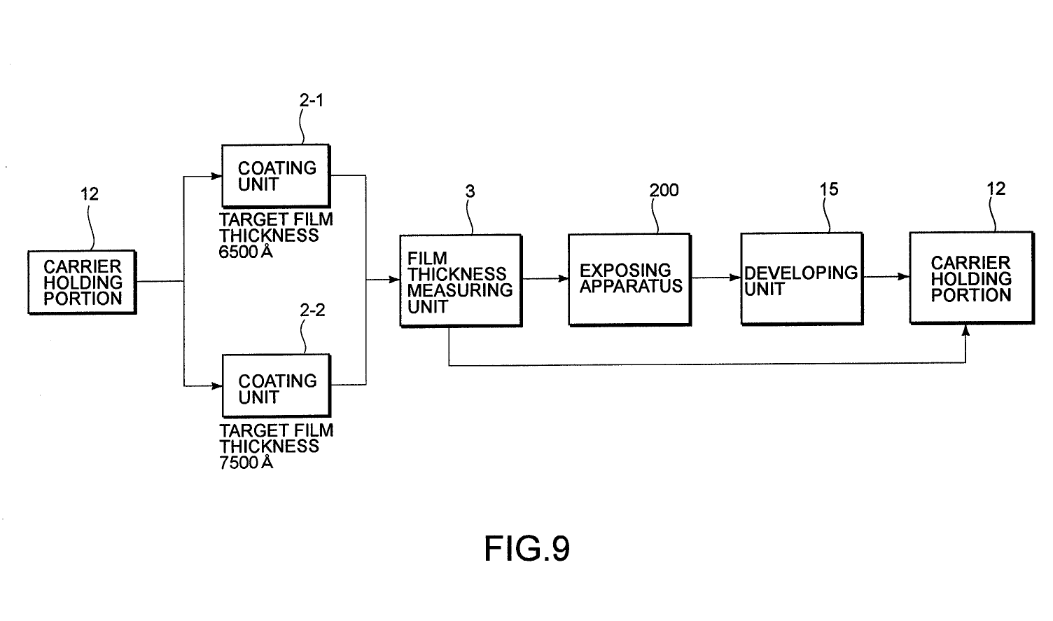

Next, based on the model shown in FIG. 8, with reference to the transferring route of a wafer W shown in FIG. 9, the operation of the embodiment will be described. In the example, it is assumed that two coating units 2-1 and 2-2 that use the same resist solution are used in the above-described coating film forming apparatus. The recipes A and MA recite that wafers W are processed through the coating unit 2-1, whereas the recipes B and MB recite that wafers W are processed through the coating unit 2-2. Next, the difference between the transferring path of wafers W recited in the recipes A and B in the production mode and the transferring path of wafers W recited in the recipes MA and MB in the film thickness measurement mode will be described. In the former, after a wafer W is transferred from the carrier holding portion 12, the wafer W is transferred to the coating unit 2-1 (2-2) and the film thickness measuring unit 3. Thereafter, the wafer W is returned to the carrier holding portion 12 through the aligner 200 and the developing unit 15. In the latter, after a wafer W is transferred from the film thickness measuring unit 3, the wafer W is returned to the carrier holding portion 12 not through the aligner 200 and the developing unit 15.

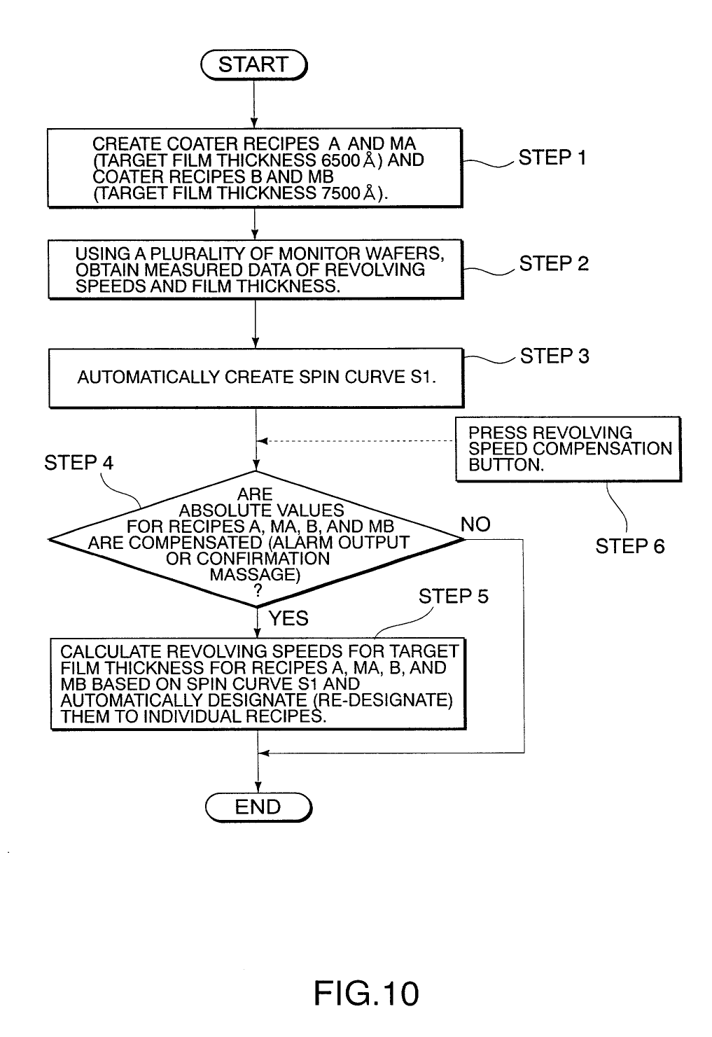

In the above-described apparatus, before a resist pattern is formed, a recipe (coater recipe) is created. When a recipe is created, it is necessary to designate (decide) target film thickness of a resist film and the revolving speed of a wafer W at which the coating film is formed. In other words, before the production is started, it is necessary to designate (decide) what film thickness is obtained at what revolving speed. Next, with reference to a flow chart shown in FIG. 10, the designating (deciding) operation will be described.

First of all, a target film thickness of 6500 Å for the recipe A is input (at step 1). Thereafter, using the monitor recipe MA, which is substantially the same as the recipe A, measured data of revolving speed and film thickness is obtained (at step 2). In reality, at step 2, the spin curve creation mode is selected by the operation mode selecting portion 44 shown in FIG. 5. A plurality of monitor wafers—for example—pair wafers are prepared. The monitor wafers are successively loaded to the coating unit 2. Various revolving speeds are designated for the monitor wafers. Resist as coating solution is coated on the front surface of each wafer. In addition, the film thickness of each resist film is measured in the film thickness measuring unit 3. At step 2, those operations are performed. The measured data of film thickness is for example the distribution of film thickness along the diameters of wafers. The spin curve S1 that represents the relation between the average film thickness of the distribution of film thickness and the revolving speeds is created by the spin curve creating portion 51. The spin curve S1 is stored to the spin curve storing portion 52 (at step 3). The spin curve S1 is created by plotting points at intervals of 40 rpm in the range from 2000 to 3000 rpm.

Thereafter, it is determined whether or not the operator decides the revolving speed corresponding to the target film thickness for each recipe based on the spin curve S1 obtained at step 3 (at step 4). When the operator wants to link the recipes A, MA, B, and MB to the spin curve S1, he or she performs an operation for deciding the spin curve linked to the recipes A and B as the spin curve S1 on the operation panel. Thus, the program of the recipe creating portion 41 obtains the revolving speed for the target film thickness from the spin curve S1, namely, obtains the revolving speed for the target film thickness of 6500 Å for the recipe A and the revolving speed for the target film thickness of 7500 Å for the recipe B, and automatically designates the obtained revolving speeds to the recipes A and B (at step 5). As with the recipes A and B, the recipe creating portion 41 automatically designates revolving speeds for the recipes MA and MB in the film thickness measurement mode. When the operator does not decide that, the process is terminated. When the operator tries to link the recipe A to the spin curve S1, for example an alarm may go off so that the operator can confirm it.

The above-described flow is applied when a spin curve is initially created in the case that the apparatus is started up or a new resist is used. For example, when a spin curve S0 (not shown) has been created, it is automatically updated to the spin curve S1 through steps 1 to 3. When the spin curve S0 is updated to the spin curve S1, it is determined whether or not the operator wants to link all the recipes A, MA, B, and MB that have been linked to the spin curve S0 to the spin curve S1 together (at step 4). When the operator has decided to do that, the revolving speeds for the target film thickness for the recipes A, MA, B, and MB based on the spin curve S1 are obtained. The obtained revolving speeds are automatically designated (re-designated) to the recipes. The term “revolving speeds are designated” represents that revolving speeds are compensated corresponding to the newly obtained spin curve (namely, absolute values are compensated). Thus, in FIG. 10, the term “absolute values are compensated” is used.

When the spin curve S0 is substituted with a prepared spin curve S1 instead of newly creating the spin curve S1, first of all, the recipes A, MA, B, and MB are linked to the spin curve S1, then the operator presses a revolving speed compensation button (not shown) (at step 6). At that time, a message appears that prompts the operator to confirm the operation for compensating the absolute values for individual recipes (at sep 4). When the operator has confirmed the operation, each recipe is automatically re-designated at step 5. When the operation has not confirmed the operation, the process is terminated.

Corresponding to the target film thickness and the revolving speeds for the recipes A and B that have been designated in such a manner, the production mode is started. For example, when a predetermined number of wafers have been processed, the recipes MA and MB in the film thickness measurement mode are selected in the recipe selecting portion 43.

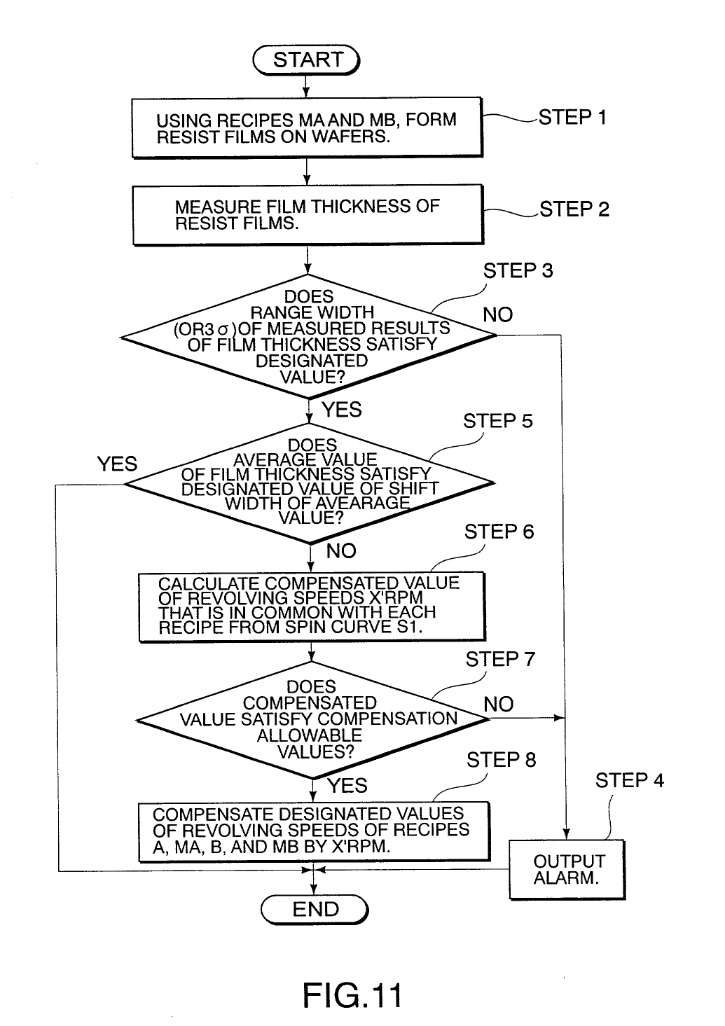

Next, with reference to FIG. 11, a process for coating resist solution on a wafer and compensating a revolving speed that has been designated corresponding to the film thickness of the coated resist film will be described. First of all, four wafer monitors are prepared. A coating process is performed for the two monitor wafers of the four monitor wafers in the coating unit 2-1 corresponding to the recipe MA. Thereafter, the coating process is performed for the remaining two monitor wafers in the coating unit 2-2 corresponding to the recipe MB (at step 1). Thereafter, the film thickness of the four monitor wafers of which the coating process has been performed is measured and the measured data of the revolving speeds and film thickness are obtained (at step 2). The measured data of the film thickness represents the range width, 3 and average value of film thickness calculated from the distribution of film thickness obtained along the diameters of the wafers. As was described above, the range width is the difference between the maximum value and the minimum value of the film thickness. 3 is a value three times larger than the standard deviation. The revolving speed compensating portion 6 determines whether or not the range width of each wafer satisfies the set value that has been designated on the set up screen shown in FIG. 6 (at step 3). When at least one of the wafers deviates from the designated range width, it is determined that the apparatus or the like is defective and causes the alarm generating portion 7 to output an alarm (at step 4). At that point, for example, the operator stops the compensating operation. When the range width of all the four wafers does not deviate from the designated value, the flow advances to step 5. Alternatively, at step 3 as a determining step, 3 may be used instead of the range width. At that point, it is determined whether or not 3 of each wafer satisfies the designated valued designated on the input screen shown in FIG. 6. When 3 of all the wafers does not deviate from the designated value, the flow advances to step 5. Further alternatively, when the range width and 3 of each wafer satisfies the designated values, the flow advances to step 5.

At step 5, it is determined whether or not the average value of film thickness of each wafer satisfies the designated value of the shift width of the average value designated on the input screen. When the average value of film thickness of all the wafers satisfies the designated value, it is not necessary to compensate the revolving speed. In other words, the coating process can be performed at the revolving speed of the currently designated value. Thus, the compensation program is terminated. In contrast, when the average value of film thickness of at least one of the four wafers deviates from the designated value, the flow advances to step 6. In the example, the shift width of the average value represents an allowable range in which the average value of film thickness that does not completely match the target film thickness can be treated as a value that does not adversely affect the process.

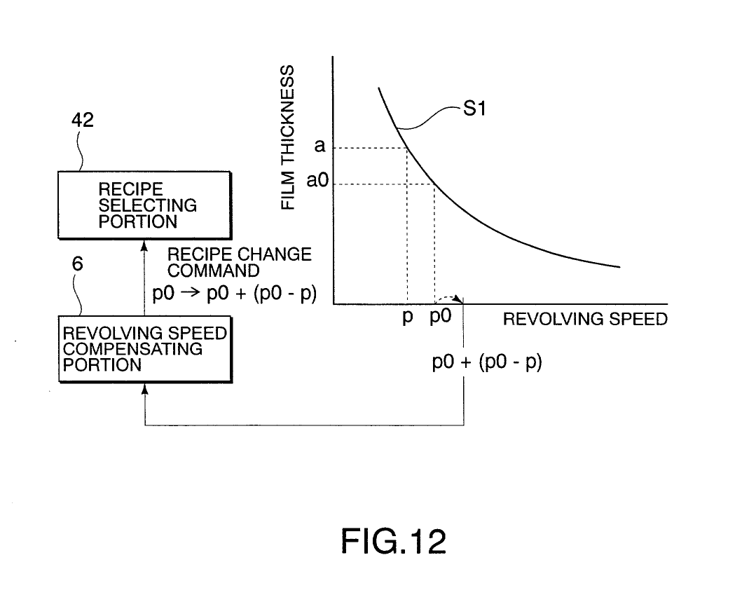

At step 6, the revolving speed of each recipe is compensated using the measured values of film thickness of the four wafers (average value of film thickness) and the spin curve S1. Next, with reference to FIG. 12, the process for compensating revolving speeds at step 6 will be described. For example, when film thickness “a” of a wafer of which a coating film was formed corresponding to the recipe MA is different from target film thickness a0, the difference between a shake-off revolving speed p corresponding to the film thickness a and a current shake-off revolving speed p0 is calculated corresponding to the spin curve S1.

Thus, it is clear that when resist solution is coated on a wafer at the revolving speed p0 corresponding to the recipe MA, the film thickness becomes “a”. However, according to the above-described spin curve S1, the revolving speed for the film thickness “a” is “p”. Thus, it can be stated that the shake-off amount of the resist solution decreases by (p0−p) and thereby the film thickness increases. Consequently, the revolving speed compensating portion 6 adds a compensation value Xrpm=(p0−p) to the current revolving speed p0 so as to relatively decrease the film thickness and cause the current film thickness to reach the target value a0.

In such a manner, the compensation value X is calculated for each of all the four wafers. However, in reality, as was described above, as for the two wafers whose coating films were formed corresponding to the recipe MA, a compensation value is calculated with the target film thickness a0 that is 6500 Å. In contrast, as for the remaining two wafers whose coating films were formed corresponding to the recipe MB, a compensation value is calculated with the target film thickness a0 that is 7500 Å. The average value X′ of the four compensation values is treated as the compensated value of the revolving speeds of the recipes A, MA, B, and MB linked to the common spin curve S1. Thus, the compensated revolving speed of the recipes A and MA is expressed by the revolving speed for the film thickness of 6500 Å plus X′ rpm. Likewise, the compensated revolving speed of the recipes B and MB is expressed by the revolving speed for the film thickness of 7500 Å plus X′ rpm.

However, when the compensated revolving speed is too large or too small, there is a situation of which the coating unit 2 cannot coat resist on wafers in the target film thickness. Thus, the flow advances to step 7. At step 7, it is determined whether or not the compensated revolving speeds of the recipes A, MA, B, and MB satisfy the compensation allowable values. Assuming that the compensated revolving speeds for the recipes A and B are 3100 rpm and 2600 rpm, respectively, the compensated revolving speed for the recipe A deviates from the allowable values (2000 to 3000 rpm), whereas the compensated revolving speed for the recipe B satisfies thereof. In such a manner, it can be determined whether or not the compensated revolving speed of each recipe satisfies the allowable values.

When there is a recipe whose compensated revolving speed deviates from the compensation allowable values, the flow advances to step 4. At step 4, an alarm is output. In contrast, when the determined result represents that the compensated revolving speeds for all the recipes satisfy the compensation allowable values, the flow advances to step 8. Corresponding to a recipe change command issued by the revolving speed compensating portion 6, the set value of the revolving speed for each recipe is compensated by the compensated value X′ rpm. Each of the rewritten recipes is stored to the recipe storing portion 42. Thereafter, using the compensated revolving speeds, the coating process for resist solution is performed.

According to the above-described embodiment, since a plurality of recipes that differ in process conditions of the coating unit can reference a common spin curve, it is not necessary to prepare a plurality of spin curves corresponding to each recipe. Even if a spin curve that has been designated is changed, all recipes can be compensated at a time (namely, absolute values can be compensated).

In addition, recipes whose process conditions are the same, but whose transferring paths for wafers are different (different modes) (recipes A and B) may be linked to one spin curve S1. Alternatively, recipes whose process conditions are different, but whose modes are the same (recipes A and MA; and recipes B and MB) may be linked to the spin curve S1. In the above-described example, since all four types of recipes are linked, after the production line is operated, when the designated revolving speeds of the recipes are compensated (namely, the relative values are compensated), with a compensated value X′ of revolving speed corresponding to one of the recipes, the designated revolving speeds of all the recipes can be rewritten at a time.

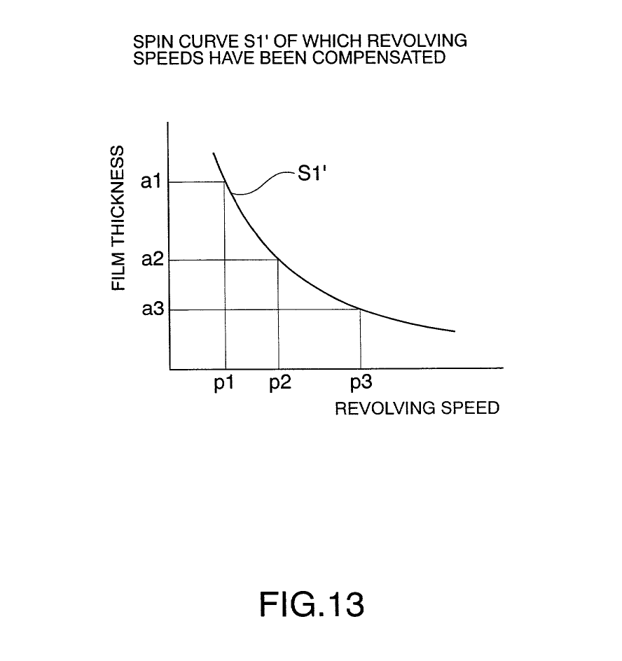

FIG. 13 shows common revolving speed—film thickness data (spin curve S1′) of which revolving speeds of recipes have been compensated in the above-described manner. As shown in FIG. 13, for example revolving speeds p1, p2, and p3 are selected from the spin curve S1′. Thereafter, film thickness a1, a2, and a3 corresponding to the revolving speeds p1, p2, and p3 are calculated, respectively.

On the other hand, at the revolving speeds p1, p2, and p3, coating films are actually formed. The film thickness of the formed coating films is actually measured. Now, the actually measured film thickness is denoted by b1, b2, and b3.

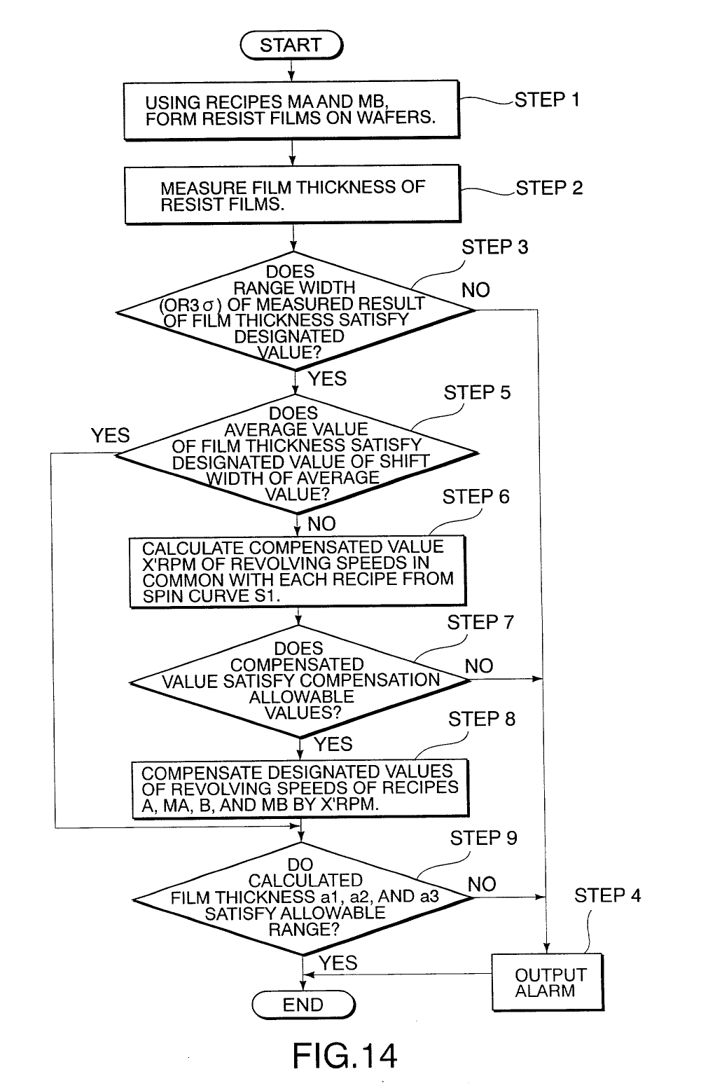

At step 9 shown in FIG. 14, it is determined whether or not the calculated film thickness a1, a2, and a3 correspond to b1, b2, and b3, respectively. At that point, even if they do not exactly match, as long as they satisfy a predetermined allowable range, it is determined that the revolving speeds have been properly compensated. In contrast, when they do not satisfy the predetermined allowable range, for example, an alarm may be output (at step 4). When compensated results are verified in such a manner, the reliability of the compensated revolving speeds can be further improved.

When the compensated results are verified, three values p1, p2, and p3 are selected as samples of revolving speeds. However, to improve the reliability of the verified results, more revolving speeds may be selected.

According to the above-described embodiment, four monitor wafers are prepared. Two wafers are processed by the coating unit 2-1 corresponding to the recipe MA, whereas the remaining two wafers are processed by the coating unit 2-2 corresponding to the recipe MB. Thereafter, the film thickness of the four monitor wafers are measured. Likewise, when the recipe MA (recipe A) and the recipe MB (recipe B) are linked to the common spin curve S1, for example, the coating process is performed for one wafer corresponding to the recipe MA. Corresponding to the obtained compensated value X, the designated revolving speeds of the recipes A, MA, B, and MB can be compensated at a time.

In addition, the number of coating units is not limited to two or more. In other words, even if the coating and developing apparatus 100 is provided with only one coating unit 2-1, a plurality of recipes whose target film thickness differs may be linked to a common spin curve regardless of whether recipes are in the production mode or the film thickness measurement mode. In such a case, the same effect as the above-described example can be obtained. In addition, according to the embodiment of the present invention, as for the structure of the coating and developing apparatus 100, the film thickness measuring unit 3 may be disposed outside thereof.

In the above-described example, substrates used according to the embodiment may be LCD substrates. In addition, as coating solution, interlayer insulation material, low dielectric material, ferrodielectric substance, wiring material, organic metal material, metal paste, or the like can be used.

As was described above, according to the present invention, when a coating film is formed on a substrate by the spin coating method, the designating operation, re-designating operation, and the optimum-compensating operation of the revolving speed of the substrate for the target film thickness of the coating film can be alleviated.

The disclosure of Japanese Patent Application No.2000-337764 filed Nov. 6, 2000 including specification, drawings and claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. An apparatus forming a coating film, comprising:
a carrier holding portion holding a carrier that contains a plurality of substrates;
a transfer mechanism extracting a substrate from the carrier held on the carrier holding portion and transferring the substrate;
a coating unit, having a substrate holding portion horizontally holding the substrate transferred from the transfer mechanism, the coating unit supplying coating solution to the substrate, and rotating the substrate holding portion so as to spread the coating solution on the substrate with a centrifugal force of a revolving speed of the substrate and thereby form a coating film on a front surface of the substrate;
a film thickness measuring unit measuring a film thickness of the coating film formed on the front surface of the substrate;
a data storing portion storing a revolving speed—film thickness data that represents the relation between the revolving speed of the substrate and the film thickness of the coating film coated in a coating process at the coating unit;
a recipe creating portion creating a recipe that recites a process condition group containing a target film thickness of the coating film of the coating unit and the revolving speed of a plurality of said substrates when the coating process is performed at the coating unit; and
a revolving speed compensating portion compensating a set value of a plurality of said revolving speeds corresponding to the target film thickness designated by a plurality of the created recipes, the measured data of the film thickness, and the revolving speed—film thickness data assigned to the recipe so that the film thickness of the coating film satisfies the target value,
wherein a plurality of recipes are assigned to a common revolving speed—film thickness data, when the revolving speed of one recipe out of a plurality of other recipes is compensated, the revolving speeds of the other recipes are being compensated.

2. The apparatus as set forth in claim 1,
wherein the revolving speed compensating portion determines a compensated value of the revolving speed corresponding to an average value of the film thickness of the substrates based on the measured data of the film thickness, the target film thickness, and the revolving speed—film thickness data.

3. The apparatus as set forth in claim 1,
wherein the plurality of recipes assigned to the common revolving speed—film thickness data recite the same types of coating solution, but a different target film thickness.

4. The apparatus as set forth in claim 1,
wherein the plurality of recipes assigned to the common revolving speed—film thickness data contain a production recipe and a film thickness measurement recipe, the production recipe being used to produce the substrates, the film thickness measurement recipe being used to perform the coating process for a monitor substrate under the same condition as the production recipe to measure the film thickness thereof.

5. The apparatus as set forth in claim 1,
wherein the revolving speed—film thickness data is assigned to each recipe by inputting a name of the revolving speed—film thickness data on a set up screen of said recipe creating portion.

6. The apparatus as set forth in claim 1,
wherein coating films are formed with using each recipe to which the common revolving speed—film thickness data is assigned, the average value of the compensated values of the revolving speeds obtained from a plurality of measured results of the film thickness of the coating films is being treated as a compensated value of the revolving speeds of the plurality of recipes.

7. The apparatus as set forth in claim 6, further comprising:
a means for calculating the film thickness for each revolving speed based on the common revolving speed—film thickness data of which the revolving speeds of the recipes have been compensated and determining whether or not each calculated result satisfies an allowable range against the measured results of the film thickness of the coating films formed at each revolving speed.

8. A method forming a coating film, comprising the steps of:
creating a recipe that recites a target film thickness of a coating film formed on a substrate and a revolving speed of the substrate at which a coating process is performed by a coating unit;
causing the coating unit to supply a coating solution to the substrate, revolving the substrate along a horizontal surface at the revolving speed designated at the creating step so as to spread the coating solution with a centrifugal force and form the coating film on a front surface of the substrate;
measuring a film thickness of the coating film formed on the front surface of the substrate;
determining a compensated value of the revolving speed corresponding to the target film thickness designated in the recipe, the measured data of the film thickness of the coating film measured at the measuring step, and a pre-created revolving speed—film thickness data assigned to the recipe so as to reach the film thickness of the coating film to a target value; and
compensating a plurality of revolving speeds of other recipes assigned to a common revolving speed—film thickness data when the revolving speed of one of the recipes is compensated.

9. The method as set forth in claim 8, further comprising the step of:
forming the coating film using each recipe assigned to the common revolving speed—film thickness data and treating the average value of the compensated values of the revolving speeds obtained from a plurality of measured results of the film thickness of the coating films as a compensated value of the revolving speeds of the recipes.

10. The method as set forth in claim 9, further comprising the step of:
calculating a film thickness for each revolving speed based on the common revolving speed—film thickness data of which the revolving speeds of the recipes have been compensated and determining whether or not each calculated result satisfies an allowable range against a measured result of the film thickness of the coating film for each of the revolving speed.
